(19) United States
(12) Patent Application Publication
(10) Pub. No.: US 2025/0172952 A1
(43) Pub. Date: May 29, 2025

(54) ELECTRONIC DEVICE FOR OBTAINING LOCATION INFORMATION OF ROBOT AND CONTROL METHOD THEREOF

(71) Applicant: SAMSUNG ELECTRONICS CO., LTD., Suwon-si (KR)

(72) Inventors: Taeyoon LEE, Suwon-si (KR); Boseok MOON, Suwon-si (KR)

(73) Assignee: SAMSUNG ELECTRONICS CO., LTD., Suwon-si (KR)

(21) Appl. No.: 19/009,522

(22) Filed: Jan. 3, 2025

Related U.S. Application Data
(63) Continuation of application No. PCT/KR2024/096513, filed on Nov. 13, 2024.

(30) Foreign Application Priority Data
Nov. 28, 2023 (KR) 10-2023-0168513

(51) Int. Cl. G05D 1/69; G05D 1/246

(52) U.S. Cl. CPC G05D 1/69; G05D 1/246

(57) ABSTRACT

There is provided an electronic device that identifies a first robot, among the plurality of robots, as a target robot that requires location information to be updated, transmits a control signal for sensing the target robot to at least one second robot among the plurality of robots, updates, based on receiving sensing data from the at least one second robot, the location information of the target robot within a space in which the plurality of robots are located, and controls the communication interface to transmit the updated location information to the target robot.

### CROSS-REFERENCE TO RELATED APPLICATION(S)

This application is a bypass continuation of International Application No. PCT/KR2024/096513, filed on Nov. 13, 2024, which is based on and claims priority to Korean Patent Application No. 10-2023-0168513, filed on Nov. 28, 2023, in the Korean Intellectual Property Office, the disclosures of which are incorporated by reference herein in their entireties.

### BACKGROUND

### 1. Field

The disclosure relates to an electronic device and a control method thereof, and more particularly, to an electronic device that obtains location information of each of a plurality of robots, and a control method thereof.

### 2. Description of the Related Art

Recently, distribution of robots is accelerating in various fields to assist humans in performing various operations. For example, there is a recent trend in which unmanned factories (e.g., smart factories) that operate only with robots with minimal or no human interaction are rapidly increasing.

In a case in which a robot travels autonomously in a factory, it is necessary to detect the surrounding environment of the robot with high accuracy such that the robot can move more easily and safely.

Also, only when the location of a robot travelling in a space is identified (or tracked) with high accuracy, risk that may be generated while the robot moves or performs an operation can be prevented.

However, when an initial location of a robot is identified using a related art method, it is difficult to correctly identify the location of the robot. Moreover, if the robot operates for a long time, it is difficult to correctly track the location of the robot.

Accordingly, there is a need for a method for correctly identifying an initial location of a robot that is newly arranged in a space. Also, there is a need for tracking the location of the robot that moved for a long time with high accuracy.

### SUMMARY

According to an aspect of the disclosure, there is provided an electronic device including: a communication interface; a memory configured to store one or more instructions; and at least one processor operatively connected with the communication interface and the memory, the at least one processor configured to execute the one or more instructions to: based on one or more signals received from one or more of a plurality of robots, identify a first robot, among the plurality of robots, as a target robot that requires location information to be updated, transmit a control signal for sensing the target robot to at least one second robot among the plurality of robots, based on receiving sensing data from the at least one second robot, update the location information of the target robot within a space in which the plurality of robots are located, and control the communication interface to transmit the updated location information to the target robot.

According to an aspect of the disclosure, there is provided a control method of an electronic device, the method including: based on one or more signals received from one or more of a plurality of robots, identify a first robot, among the plurality of robots, as a target robot that requires location information to be updated; transmitting a control signal for sensing the target robot to at least one second robot among the plurality of robots; based on receiving sensing data from the at least one second robot, updating the location information of the target robot within a space in which the plurality of robots are located; and transmitting the updated location information to the target robot.

### BRIEF DESCRIPTION OF DRAWINGS

These and other features, aspects, and advantages of the disclosure will become better understood when the following detailed description is read with reference to the accompanying drawings in which like characters represent like parts throughout the drawings, wherein:

FIG. 1 is a diagram for illustrating an electronic device communicating with a plurality of robots according to an embodiment of the disclosure;

FIG. 2 is a block diagram for illustrating an electronic device according to an embodiment of the disclosure;

FIG. 3 is a diagram for illustrating a target robot and at least one robot sensing the target robot according to an embodiment of the disclosure;

FIG. 4 is a diagram for illustrating an electronic device updating location information of at least one robot according to an embodiment of the disclosure;

FIG. 5 is a diagram for illustrating a method of identifying at least one robot of which needs location information to be updated based on map information according to an embodiment of the disclosure;

FIG. 6 is a diagram for illustrating a method of identifying at least one robot of which needs location information to be updated based on signals received by a predetermined time interval according to an embodiment of the disclosure;

FIGS. 7A and 7B are diagrams for illustrating a method of updating location information of at least one robot among a plurality of robots according to an embodiment of the disclosure;

FIGS. 8A and 8B are diagrams for illustrating an electronic device that controls a movement of a target robot in a situation in which it is impossible to sense the target robot according to an embodiment of the disclosure;

FIG. 9 is a diagram for illustrating a method for robot devices connected to the same network to share identification information according to an embodiment of the disclosure;

FIG. 10 is a block diagram for illustrating a robot according to an embodiment of the disclosure; and

FIG. 11 is a flow chart for illustrating a control method of an electronic device according to an embodiment of the disclosure.

### DETAILED DESCRIPTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. Further, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, a block including “a module”, “a unit” or “a part” performs at least one function or operation, and may be implemented as hardware or software, or as a combination of hardware and software. Also, a plurality of “modules” or “parts” may be integrated into at least one module and implemented as at least one processor, except “a module” or “a part” that needs to be implemented as specific hardware.

Further, in this specification, the term “user” may refer to a person who uses an electronic device or a device using an electronic device (e.g.: an artificial intelligence electronic device).

Hereinafter, an embodiment of the disclosure will be described in more detail with reference to the accompanying drawings.

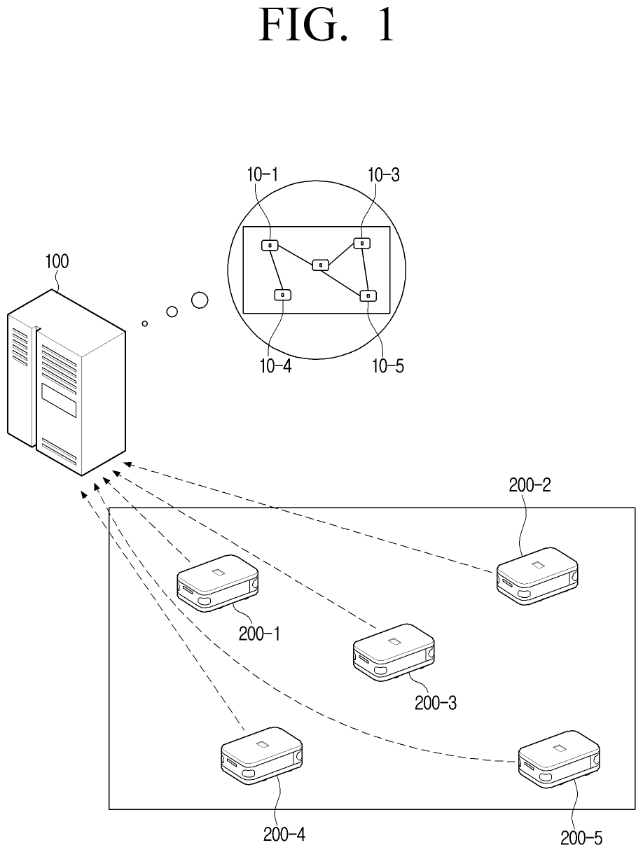

FIG. 1 is a diagram for illustrating an electronic device communicating with a plurality of robots according to an embodiment of the disclosure.

An electronic device 100 according to an embodiment of the disclosure may perform communication with a plurality of robots 200, and exchange various kinds of data with the plurality of robots 200. For example, the electronic device 100 may transmit one or more data to the plurality of robots 200 and receive one or more data from the plurality of robots 200. The one or more data may include various kinds of data. The plurality of robots 200 may include a first robot 200-1, a second robot 200-2, a third robot 200-3, a fourth robot 200-4 and a fifth robot 200-5. However, the disclosure is not limited thereto, and as such, according to another embodiment, the number of robots may be different than five.

According to an embodiment, the electronic device 100 may control one or more of the plurality of robots 200. According to an embodiment, the electronic device 100 may control each of the plurality of robots 200. For example, the electronic device 100 may monitor the locations of each of the plurality of robots 200. According to an embodiment, the electronic device 100 may control collaboration among the plurality of robots 200 for performing a task, or schedule the operations of each of the plurality of robots 200.

According to an embodiment, one or more of the plurality of robots 200 may move according to a control by the electronic device 100. However, the disclosure is not limited thereto, and as such, the one or more of the plurality of robots 200 may move autonomously. According to an embodiment, each of the plurality of robots 200 may move within a space according to control by the electronic device 100, or autonomously.

In an example case in which the first robot 200-1 among the plurality of robots 200 performs an operation that requires moving, the first robot 200-1 may move within a space by controlling a driving mechanism including a wheel, a brake, a motor, etc. According to an embodiment, the electronic device 100 may monitor change of a location according to the movement of the first robot 200-1 in real time. However, the disclosure is not limited thereto, and as such, according to another embodiment, the electronic device 100 may monitor change of a location according to the movement of the first robot 200-1 within a reference time interval. The reference time interval may be a predetermined time interval.

According to an embodiment, the electronic device 100 may receive signals from one or more of the plurality of robots 200, and obtain location information of the one or more of the plurality of robots 200 based on the received signals. For example, the electronic device 100 may receive signals from each of the plurality of robots 200, and obtain location information of each of the plurality of robots 200 based on the received signals.

For example, each of the plurality of robots 200 may perform a simultaneous localization and mapping (SLAM) operation. For example, each of the plurality of robots 200 may identify its location through a SLAM operation, and transmit a signal including the identified location to the electronic device 100. The electronic device 100 according to an embodiment may collaborate the locations included in the signals received from each of the plurality of robots 200, and obtain the location information corresponding to each of the plurality of robots 200 within the space.

According to an embodiment, one or more of the plurality of robots 200 may sense a surrounding environment, and transmit a signal including information related to the surrounding environment. For example, one or more of the plurality of robots 200 may sense or obtain one or more characteristics of the surrounding environment, and transmit a signal including information related to the surrounding environment. According to an embodiment, each of the plurality of robots 200 may sense the surrounding environment, and transmit a signal including the obtained sensing data. For example, the electronic device 100 may analyze the obtained sensing data included in the signals received from one or more of the plurality of robots 200, and obtain the location information corresponding to one or more of the plurality of robots 200. For example, the electronic device 100 may analyze sensing data included in the signals received from each of the plurality of robots 200, and obtain the location information corresponding to each of the plurality of robots 200 within the space.

For example, the first robot 200-1 among the plurality of robots 200 may transmit sensing data to the electronic device 100. The sensing data may include, but not limited to, a distance from another robot, an arrangement relation between the first robot 200-1 and another robot, a distance from an object, and the size and the location of the object, etc. For example, another robot may be a second robot 200-2 adjacent to the first robot 200-1 or a robot that can be sensed (or detected) through a sensor provided on the first robot 200-1. The arrangement relation between the first robot 200-1 and another robot may be an arrangement direction (or orientation) of the second robot 200-2 with respect to the first robot 200-1. The object may be an obstacle adjacent to the first robot 200-1 or in the vicinity of the to the first robot 200-1. The size and the location of the object may be the size or the location of the obstacle.

According to an embodiment, the electronic device 100 may obtain the location information corresponding to each of the plurality of robots 200 in consideration of the distance among the plurality of robots 200, the arrangement relation among the plurality of robots 200, etc., by using the sensing data received from each of the plurality of robots 200.

Meanwhile, for preventing or reducing a safety problem that may occur during moving of each of the plurality of robots 200, and for appropriately controlling the moving routes (or movement routes) of each of the plurality of robots 200, it is necessary to correctly identify the locations of each of the plurality of robots 200. However, it may difficult to correctly identify the locations of each of the plurality of robots 200 due to various reasons. The various reasons may include, but is not limited to, the area of the space in which the plurality of robots 200 are located may be very large, the space may lack of a reference object (e.g., a landmark) used as a standard for determining a location within the space, the performance of the sensors (e.g., LiDAR sensors) provided on each of the plurality of robots 200, or the space may be a featureless space.

For example, there is a problem that a difference between the actual location of the first robot 200-1 among the plurality of robots 200 and the location according to a signal received from the first robot 200-1 (e.g., location information) gradually increases according to passage of time.

According to the various embodiments of the disclosure, the electronic device 100 may identify a first robot 200-1, which requires its location information to be updated. For example, the electronic device 100 may identify a first robot 200-1 for which location information needs to be obtained with high accuracy (or with high reliability).

For example, the electronic device 100 may obtain the location information of the first robot 200-1 by using not only the sensing data received from the first robot 200-1, but also using data from other remaining robots surrounding the first robot 200-1. For example, the electronic device 100 may control the at least one of the remaining robots (e.g., the second to fifth robots 200-2 to 200-5) to sense the first robot 200-1, and obtain (or update) the location information corresponding to the first robot 200-1 by using the sensing data obtained by the at least one of the remaining robots by sensing the first robot 200-1, and transmit the information to the first robot 200-1.

According to an embodiment, the electronic device 100 obtains the location information corresponding to the first robot 200-1 based on the sensing data received from the first robot 200-1, and the sensing data received from the at least one of the remaining robots that sensed the first robot 200-1, and thus the location information of the first robot 200-1 can be obtained with high accuracy.

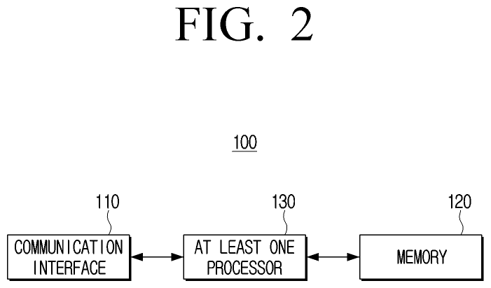

FIG. 2 is a block diagram for illustrating an electronic device according to an embodiment of the disclosure.

Referring to FIG. 2, the electronic device 100 includes a communication interface 110, memory 120, and at least one processor 130.

According to an embodiment, the communication interface 110 can obviously be implemented as various interfaces depending on implementation examples of the electronic device 100. For example, the communication interface 110 may perform communication with the plurality of robots 200, etc. through communication methods such as Bluetooth, AP-based Wi-Fi (Wi-Fi, a wireless LAN network), Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc. Also, according to an embodiment, the communication interface 110 may perform communication with another electronic device, an external server, and/or a remote control device, etc.

According to an embodiment, the memory 120 may store data necessary for the various embodiments of the disclosure. The memory 120 may be implemented in a form of memory embedded in the electronic device 100, or implemented in a form of memory that can be attached to or detached from the electronic device 100 according to the use of stored data.

For example, in the case of data for driving the electronic device 100, the data may be stored in memory embedded in the electronic device 100, and in the case of data for an extended function of the electronic device 100, the data may be stored in memory that can be attached to or detached from the electronic device 100.

According to an embodiment, in an example case in which a memory is embedded in the electronic device 100, the memory may be implemented in various forms, including but not limited to, volatile memory (e.g.: dynamic RAM (DRAM), static RAM (SRAM), or synchronous dynamic RAM (SDRAM), etc.), non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)), etc.

In the case of memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.) and external memory that can be connected to a USB port (e.g., a USB memory), etc.

According to an embodiment, the memory 120 may store a computer program including at least one instruction or instructions for controlling the electronic device 100.

According to an embodiment, the at least one processor 130 controls the overall operations of the electronic device 100. Specifically, the at least one processor 130 may be connected with each component of the electronic device 100, and control the overall operations of the electronic device 100.

The at least one processor 130 may perform the operations of the electronic device 100 according to the various embodiments by executing the at least one instruction stored in the memory 120.

The at least one processor 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 130 may control one or a random combination of the other components of the electronic device, and perform an operation related to communication or data processing. Also, the at least one processor 130 may execute one or more programs or instructions stored in the memory 120. For example, the at least one processor 130 may perform the method according to an embodiment of the disclosure by executing the at least one instruction stored in the memory 120.

In case the method according to an embodiment of the disclosure includes a plurality of operations, the plurality of operations may be performed by one processor, or performed by a plurality of processors. In an example case in which a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 130 may be implemented as a single core processor including one core, or may be implemented as one or more multicore processors including a plurality of cores (e.g., multicores of the same kind or multicores of different kinds). In case the at least one processor 130 is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. In an example case in which the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) in which at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

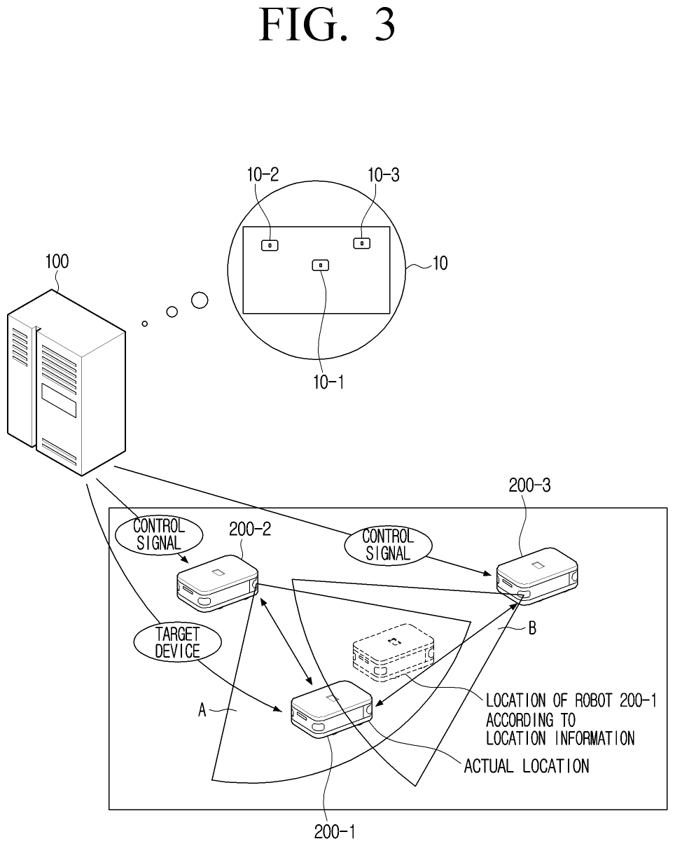

FIG. 3 is a diagram for illustrating a target robot and at least one robot sensing the target robot according to an embodiment of the disclosure.

Referring to FIG. 3, the at least one processor 130 according to an embodiment may obtain location information 10 of the plurality of robots 200 based on signals received from each of the plurality of robots 200. According to an embodiment illustrated in FIG. 3, the plurality of robots 200 include a first robot 200-1, a second robot 200-2 and a third robot 200-3. However, the disclosure is not limited thereto, and as such, the number of robots may be different than three.

The at least one processor 130 according to an embodiment may identify a first robot 200-1, which requires an update of the location information 10 based on the location information 10 corresponding to each of the plurality of robots 200.

In an example case in which it is identified that update of the location information 10-1 of the first robot 200-1 is required, the at least one processor 130 may identify the first robot 200-1 as a target robot.

According to another embodiment, the at least one processor 130 may transmit the control signal for sensing the target robot to one or more of the remaining robots. For example, the at least one processor 130 according to an embodiment may transmit a control signal for sensing the target robot to a second robot 200-2 and a third robot 200-3, among the remaining robots. However, the disclosure is not limited thereto, and as such, according to an embodiment, the at least one processor 130 may transmit the control signal for sensing the target robot to all the remaining robots.

For example, based on the location information 10-1 before update of the first robot 200-1 which is the target robot (e.g., the initial location information of the first robot 200-1, or the final location information of the first robot 200-1), the at least one processor 130 may identify the second robot 200-2 and/or the third robot 200-3 located within a reference distance of the first robot 200-1 among the remaining robots. The reference distance may be a threshold distance or a predetermined distance.

According to an embodiment, the at least one processor 130 may transmit a control signal including identification information of the first robot 200-1 and the location information 10-1 before update of the first robot 200-1 to the second robot 200-2 and the third robot 200-3.

According to an embodiment, each of the second robot 200-2 and the third robot 200-3 may identify the first robot 200-1 among the plurality of robots 200 based on the identification information of the first robot 200-1.

Here, the identification information may include various forms of information by which the first robot 200-1 can be identified among the plurality of robots 200. For example, the identification information of the first robot 200-1 may include unique shape information of the first robot 200-1 that is differentiated from the remaining robots. However, the disclosure is not limited thereto, and the identification information may include information on an identifier illustrated on the surface of the main body of the first robot 200-1, information on a quick response (QR) code, etc.

However, the disclosure is not limited thereto, and the identification information can obviously include authentication information by which communication with a corresponding robot (e.g., the first robot 200-1) among the plurality of robots 200 is possible. For example, the remaining robots can obviously communicate with the first robot 200-1 (e.g., Wi-Fi Direct communication) through the authentication information included in the identification information.

According to an embodiment, each of the second robot 200-2 and the third robot 200-3 can identify the first robot 200-1 more quickly by using the location information 10-1 before update in addition to the identification information.

For example, although the location information 10-1 before update does not correctly correspond to the actual location of the first robot 200-1, the location information 10-1 indicates an approximate location of the first robot 200-1, or a location adjacent to the actual location of the first robot 200-1, and thus each of the second robot 200-2 and the third robot 200-3 does not identify the first robot 200-1 by sensing the entire space, but sets a sensing range of the sensor based on the location information 10-1 before update, and accordingly, the second robot 200-2 and the third robot 200-3 can identify the first robot 200-1 more quickly.

For example, each of the second robot 200-2 and the third robot 200-3 may sense the first robot 200-1 (e.g., the target robot).

Each of the second robot 200-2 and the third robot 200-3 may transmit sensing data obtained by sensing the target robot to the electronic device 100. For example, each of the second robot 200-2 and the third robot 200-3 second robot 200-2 and the third robot 200-3 may include a sensor, and sense the target robot through the sensor according to a control signal.

According to an embodiment, a sensor may include a Light Detection And Ranging (LiDAR) sensor, a depth camera (e.g., Time of Flight (ToF)), an RGB camera, etc.

For example, sensing data may include distance data from the target robot that was obtained through a LiDAR sensor, a depth camera, etc. provided on each of the second robot 200-2 and the third robot 200-3. For example, a LiDAR sensor provided on each of the second robot 200-2 and the third robot 200-3 may shoot (or emit) a light to a target object (e.g., a target robot) by using a light source, and detect a reflected light by a sensor around the light source. Then, the LiDAR sensor may measure the time that was taken until the light returns, and calculate the distance to the target object (e.g., the target robot) with high accuracy and reliability by using the speed of light that is always constant.

For example, the sensing data may include pose data of the target robot that was obtained through an RGB camera, etc., and sensing direction data of the target robot (e.g., the arrangement relation data between the second robot 200-2 and the third robot 200-3 and the target robot).

For example, the sensing data may include an image including the target robot and an object adjacent to the target robot (or according to the ambient environment of the target robot).

However, the disclosure is not limited thereto, and the sensing data may include sensing direction data of the target robot according to an angle by which the main body of each of the second robot 200-2 and the third robot 200-3 rotated for detecting the target robot. For example, each of the second robot 200-2 and the third robot 200-3 may include a sensor (e.g., a LiDAR sensor, an RGB camera, etc.) arranged to sense the front side, and the sensor may obtain the angle by which the main body of each of the second robot 200-2 and the third robot 200-3 rotated for detecting the target robot as the sensing direction data.

In an example case in which the sensing data is received from the second robot 200-2 and the third robot 200-3, the at least one processor 130 may update the location information of the target robot based on the location information 10-2 of the second robot 200-2 and the location information 10-3 of the third robot 200-3, and the received sensing data.

However, this is merely an example, and the sensor may include an inertia measurement unit (referred to as an IMU hereinafter) including at least one of a gyroscope sensor, an accelerometer sensor, or a magnetometer or compass sensor.

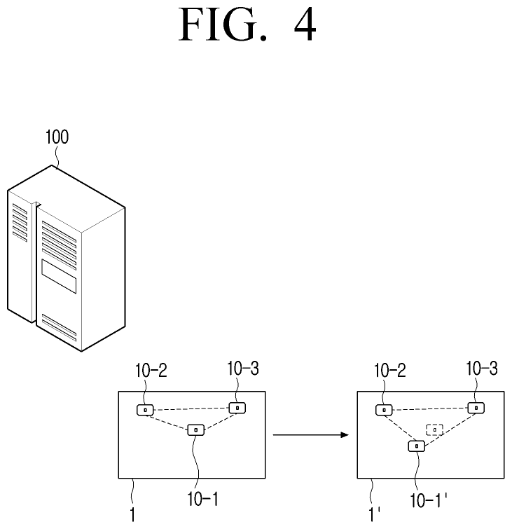

FIG. 4 is a diagram for illustrating an electronic device updating location information of at least one robot according to an embodiment of the disclosure.

Referring to FIG. 4, the electronic device 100 according to an embodiment of the disclosure may include memory 110, which stores, in advance, map information 1 corresponding to a space in which the plurality of robots 200 are located. However, the disclosure is not limited thereto, and as such, the electronic device 100 obtain map information 1 corresponding to the space based on signals received from each of the plurality of robots 200.

As illustrated in FIG. 3, a difference is generated between the location information 10-1 corresponding to the first robot 200-1 obtained based on a signal received from the first robot 200-1 and the actual location of the first robot 200-1 within the space, and the at least one processor 130 may update the location information 10-1 corresponding to the first robot 200-1 based on the sensing data received from the second robot 200-2 and the third robot 200-3 that sensed the target robot.

For example, the at least one processor 130 may identify candidate locations, in which, the target robot can be located based on the distance data from the target robot included in the sensing data received from the second robot 200-2 and the third robot 200-3 that sensed the target robot.

Then, the at least one processor 130 may identify any one of the candidate locations as the location of the target robot based on the sensing direction data of the target robot included in the sensing data received from the second robot 200-2 and the third robot 200-3 that sensed the target robot.

However, the disclosure is not limited thereto, and the at least one processor 130 may identify the location of the target robot based on the pose data of the target robot included in the sensing data received from the second robot 200-2 and the third robot 200-3 that sensed the target robot, or an image of the target robot captured by the RGB camera.

For example, the at least one processor 130 may identify the target robot, and an object adjacent to the target robot (or according to the ambient environment of the target robot) (e.g., a reference object (e.g., a landmark, a charging station, a marker, etc.), an obstacle, etc.) by analyzing an image included in the sensing data received from the second robot 200-2 and the third robot 200-3, and identify the location of the target robot based on the distance and the arrangement relation between the target robot and the object.

According to an embodiment, the at least one processor 130 may update the location information 10-1 of the target robot based on the identified location.

According to an embodiment, the at least one processor 130 may transmit the map information 1′ including the updated location information 10-1′ to the first robot 200-1.

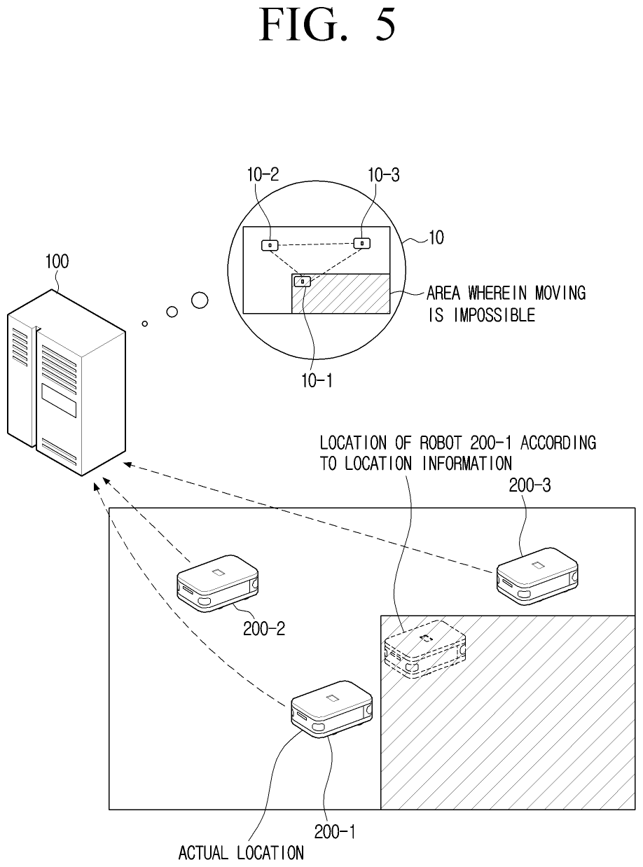

FIG. 5 is a diagram for illustrating a method of identifying at least one robot of which location information needs to be updated based on map information according to an embodiment of the disclosure.

In an example case in which a signal is not received from the first robot 200-1, or acquisition of the location information 10-1 of the first robot 200-1 fails based on a signal received from the first robot 200-1, the at least one processor 130 may identify the first robot 200-1 as the target robot.

In an example case in which time that passed after obtaining the location information 10-1 of the first robot 200-1 exceeds the threshold time, the at least one processor 130 may identify that update of the location information 10-1 of the first robot 200-1 is required.

In an example case in which the time that passed after obtaining the location information 10-1 of the first robot 200-1 exceeded the threshold time, it is necessary to update the location information 10-1 for reflecting moving of the first robot 200-1, and thus the at least one processor 130 may identify the first robot 200-1 as the target robot.

According to an embodiment, the electronic device 100 may include map information 1 corresponding to a space, and the map information 1 may divide the space into a plurality of sub areas. For example, the map information 1 may divide a space into a plurality of sub areas by dividing the space into an area in which moving is possible and an area in which moving is impossible.

For example, the at least one processor 130 may obtain map information corresponding to a space based on signals received from each of the plurality of robots 200 according to Simultaneous Localization and Mapping (SLAM) operations of each of the plurality of robots 200, and identify the current location of the electronic device 100 within the map information.

The at least one processor 130 may identify the location, the size, and the shape of an obstacle (e.g., factory equipment (e.g., a production machine), furniture, a home appliance, a wall, etc.) within the space based on the signals received from each of the plurality of robots 200, and identify an area in which moving is impossible due to the obstacle within the space.

In an example case in which it is identified that the location of the first robot 200-1 is included in an area in which moving is impossible in the map information 1 based on the location information 10-1 of the first robot 200-1, the at least one processor 130 may identify that update of the location information 10-1 of the first robot 200-1 is required. According to an embodiment, the at least one processor 130 may identify the first robot 200-1 as the target robot.

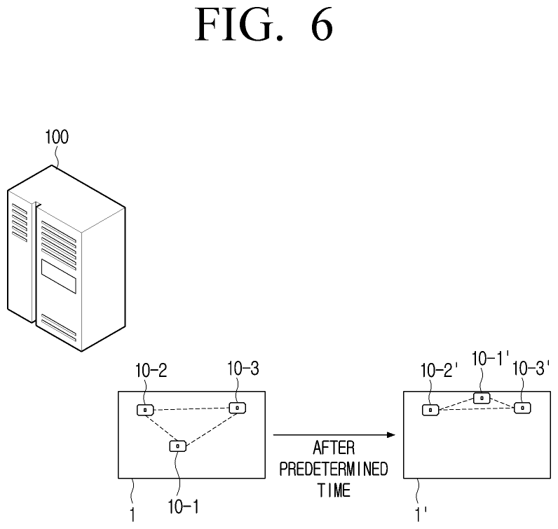

FIG. 6 is a diagram for illustrating a method of identifying at least one robot of which location information needs to be updated based on signals received by a predetermined time interval according to an embodiment of the disclosure.

Referring to FIG. 6, for monitoring the locations of each of the plurality of robots 200, the at least one processor 130 may obtain the location information 10 corresponding to each of the plurality of robots 200 based on signals received from the plurality of robots 200 in real time (or by a predetermined interval).

According to an embodiment, the at least one processor 130 may track change of the locations of each of the plurality of robots 200 based on signals received by the predetermined time interval.

For example, the at least one processor 130 may track change of the location of the first robot 200-1 based on a signal received from the first robot 200-1 by the predetermined time interval. In an example case in which it is identified that the location of the first robot 200-1 is changed abnormally, the at least one processor 130 may identify that update of the location information of the first robot 200-1 is required.

For example, the location of the first robot 200-1 cannot be changed to exceed ‘a time X corresponding to the moving speed of the first robot 200-1.’ In an example case in which it is identified that the location of the first robot 200-1 was changed to exceed the moving speed of the first robot 200-1, the at least one processor 130 may identify that update of the location information of the first robot 200-1 is required.

However, the disclosure is not limited thereto, and according to an embodiment, based on the first robot 200-1 repeatedly moving only in a specific location within the space, or based on the first robot 200-1 staying in the specific location for period of time greater than a threshold time, the at least one processor 130 may identify that update of the location information of the first robot 200-1 is required.

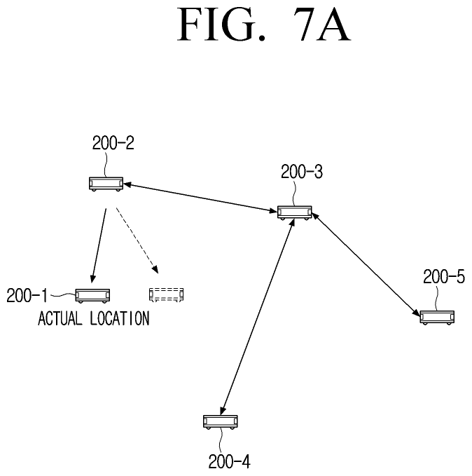

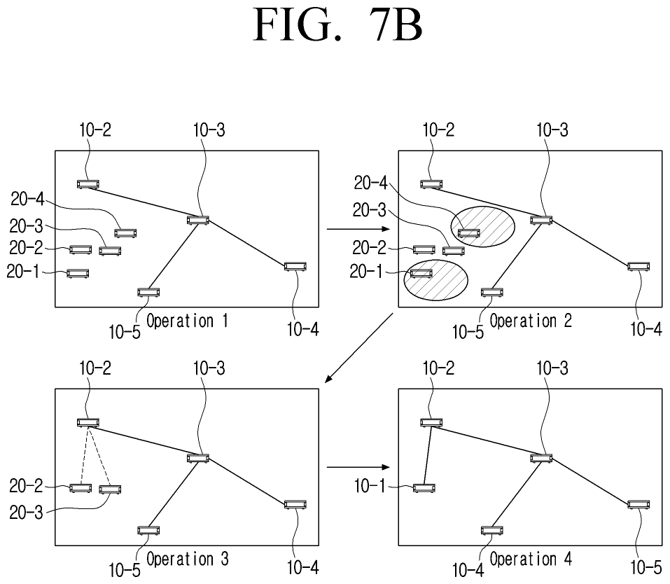

FIGS. 7A and 7B are diagrams for illustrating a method of updating location information of at least one robot among a plurality of robots according to an embodiment of the disclosure.

Referring to FIG. 7A, the at least one processor 130 may identify the first robot 200-1 that was connected with the electronic device 100 most recently (or the latest) among the plurality of robots 200 (e.g., first to fifth robots 200-1 to 200-5) as the target device, based on the order that each of the plurality of robots 200 is connected with the electronic device 100 through the communication interface 110.

In an example case in which the first robot 200-1 among the plurality of robots 200 is newly arranged within a space to perform an operation, and is connected with the electronic device 100, the location information 10-1 of the first robot 200-1 that the electronic device 100 obtained based on a signal received from the first robot 200-1 may be rather incorrect, or it may not be easy for the electronic device 100 to obtain the location information 10-1 of the first robot 200-1.

In an example case in which the first robot 200-1 among the plurality of robots 200 is reset (or restarted) according to occurrence of an event, the location information 10-1 of the first robot 200-1 may be rather incorrect, or it may not be easy to obtain the location information 10-1 of the first robot 200-1.

Here, an event may include, but is not limited to, occurrence of an error, receipt of a reset (or restart) instruction, a user manipulation changing a location manually, etc.

According to an embodiment, the at least one processor 130 may update the location information 10-1 of the first robot 200-1 by using the remaining robots.

For example, as illustrated in operation 1 in FIG. 7B, the at least one processor 130 may identify candidate locations 20-1, 20-2, 20-3, 20-4 corresponding to the first robot 200-1 based on a signal received from the first robot 200-1.

For example, the at least one processor 130 may identify the candidate locations 20-1, 20-2, 20-3, 20-4 corresponding to the first robot 200-1 based only on a signal received from the first robot 200-1 without considering the relation between the first robot 200-1 and the remaining robots (e.g., the separated distance, etc.), or identify the candidate locations 20-1, 20-2, 20-3, 20-4 corresponding to the first robot 200-1 based on the location history of the first robot 200-1 (e.g., the location of the first robot 200-1 that the electronic device 100 previously identified, the final location of the first robot 200-1), etc.

As illustrated in operation 2 in FIG. 7B, the at least one processor 130 may identify an area in which moving is possible and an area in which moving is impossible based on map information corresponding to a space. According to an embodiment, the at least one processor 130 may exclude the first candidate location 20-1 and the fourth candidate location 20-4 included in the area in which moving is impossible among the candidate locations 20-1, 20-2, 20-3, 20-4 corresponding to the first robot 200-1.

As illustrated in operation 3 in FIG. 7C, the at least one processor 130 may identify the at least one second robot 200-2 that is located within a threshold distance from at least one of the second candidate location 20-2 or the third candidate location 20-3 corresponding to the first robot 200-1 based on the location information 10-2, 10-3, 10-4, 10-5 corresponding to each of the remaining robots.

Then, the at least one processor 130 may control the at least one second robot 200-2 to sense the first robot 200-1.

In an example case in which sensing data is received from the at least one second robot 200-2 that sensed the first robot 200-1, the at least one processor 130 may obtain the location information 10-1 corresponding to the first robot 200-1 based on the sensing data.

For example, the at least one processor 130 may obtain any one of the second candidate location 20-2 and the third candidate location 20-3 as the location information 10-1 corresponding to the first robot 200-1 based on the sensing data received from the at least one second robot 200-2.

However, the disclosure is not limited thereto, and the at least one processor 130 may obtain the location information 10-1 of the first robot 200-1 based on at least one of the distance data among the first robot 200-1, the pose data of the first robot 200-1, or the sensing direction data of the first robot 200-1 that are included in the sensing data received from the at least one second robot 200-2. Here, the location information 10-1 of the first robot 200-1 may not correspond to any one of the second candidate location 20-2 and the third candidate location 20-3.

As illustrated in operation 4 in FIG. 7D, in an example case in which the at least one processor 130 obtains the location information 10-1 corresponding to the first robot 200-1, the at least one processor 130 may transmit the location information 10-1 to the first robot 200-1.

According to an embodiment, the first robot 200-1 may receive the location information 10-1, and set a moving route based on the location information 10-1, or perform a SLAM operation.

According to an embodiment, each of the plurality of robots 200 within the space may obtain corresponding location information with high accuracy or receive it from the electronic device 100, and perform a SLAM operation by using the corresponding location information.

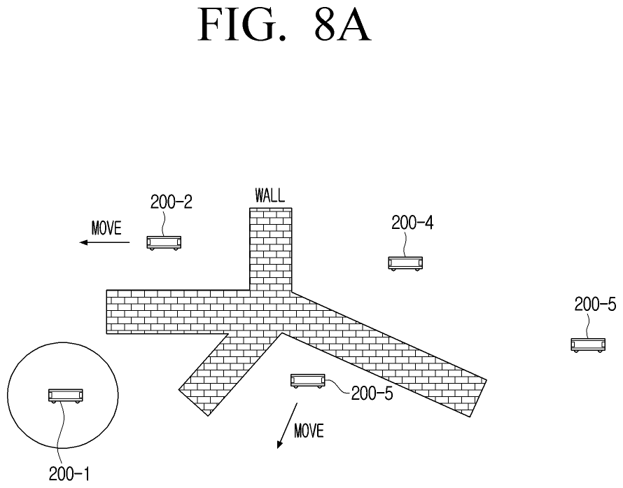

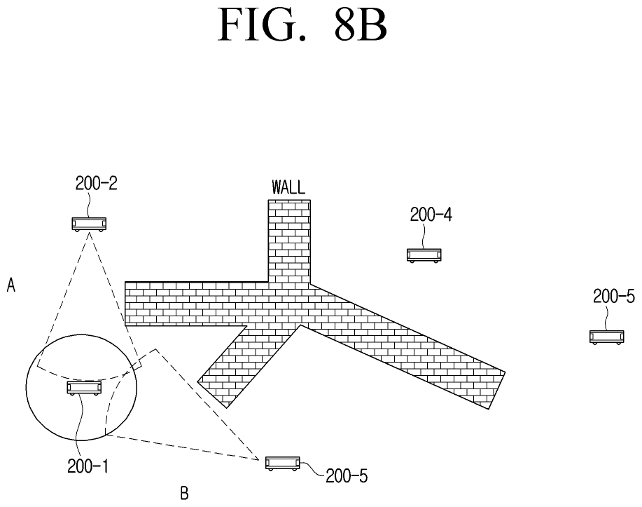

FIGS. 8A and 8B are diagrams for illustrating an electronic device that controls moving of a target robot in a situation in which it is impossible to sense the target robot according to an embodiment of the disclosure.

Referring to FIG. 8A, while the plurality of robots are operating (or moving), each of the plurality of robots 200 within the space may not sense other robots.

In an example case in which the at least one processor 130 identifies the at least one first robot as the target robot 200-1, the at least one processor 130 may control the target robot to identify second robot 200-2 and the third robot 200-3 adjacent to the target robot.

According to an embodiment, the target robot may sense the second robot 200-2 and the third robot 200-3 adjacent to the target robot through a sensor included in the target robot.

In an example case in which the target robot identifies the second robot 200-2 and the third robot 200-3, as the second robot 200-2 and the third robot 200-3 are adjacent to the target robot, the at least one processor 130 may control the second robot 200-2 and the third robot 200-3 to sense the target robot. For example, the at least one processor 130 may update the location information of the target robot based on the sensing data received from the second robot 200-2 and the third robot 200-3.

According to an embodiment, the sensor included in the target robot may not sense the second robot 200-2 and the third robot 200-3 adjacent to the target robot. In an example case in which the sensor included in the target robot is unable to (or cannot) sense the second robot 200-2 and the third robot 200-3 due to an obstacle adjacent to the target robot (e.g., a wall, equipment), the at least one processor 130 may restrict the moving range of the target robot before updating the location information of the target robot.

In an example case in which the sensor included in the target robot is unable to (or cannot) sense the second robot 200-2 and the third robot 200-3 adjacent to the target robot, the second robot 200-2 and the third robot 200-3 adjacent to the target robot may not sense the target robot, either, and the at least one processor 130 cannot identify the correct location of the target robot before updating the location information of the target robot based on the sensing data received from the second robot 200-2 and the third robot 200-3 that sensed the target robot, and thus the at least one processor 130 may restrict the moving of the target robot. For example, the at least one processor 130 may restrict the moving speed of the target robot, or restrict the moving range of the target robot within a predetermined radius.

In another example case in which the sensors included in each of the second robot 200-2 and the third robot 200-3 adjacent to the target robot cannot sense the target robot, the at least one processor 130 can obviously restrict the moving of the target robot before updating the location information of the target robot.

As illustrated in FIG. 8B, in an example case in which the second robot 200-2 and the third robot 200-3 adjacent to the target robot moves, and the sensor included in the target robot senses the second robot 200-2 and the third robot 200-3, the at least one processor 130 may transmit a control signal to the second robot 200-2 and the third robot 200-3 to sense the target robot.

In an example case in which sensing data is received from the second robot 200-2 and the third robot 200-3, the at least one processor 130 may update the location information of the target robot within the space based on the received sensing data. Although, FIG. 8 illustrates an example case in which the second robot 200-2 and the third robot 200-3 are used to sense the target robot, the disclosure is not limited thereto, and as such, according to an embodiment, one or more of the remaining robots may be used to sense the target robot. For example, one of the second robot 200-2 or the third robot 200-3 may be used to sense the target robot.

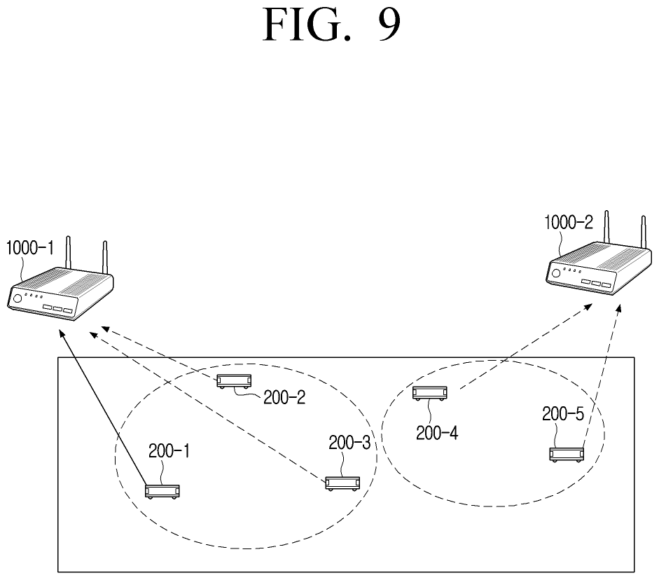

FIG. 9 is a diagram for illustrating a method for robot devices connected to the same network to share identification information according to an embodiment of the disclosure.

Referring to FIG. 9, a plurality of access points (APs) 1000-1, 1000-2 may be provided within a space.

According to an embodiment, each of the plurality of robots 200 may be connected to any one of the plurality of APs 1000-1, 1000-2, and communicate with the electronic device 100.

According to an embodiment, the at least one processor 130 may group robots connected to the same AP.

In an example case in which the second robot 200-2 and the third robot 200-3 are connected to the first AP 1000-1, and the fourth robot 200-4 and the fifth robot 200-5 are connected to the second AP 1000-2, the at least one processor 130 may control the second robot 200-2 and the third robot 200-3 connected to the same first AP 1000-1 to sense each other, and control the fourth robot 200-4 and the fifth robot 200-5 connected to the same second AP 1000-2 to sense each other.

In an example case in which a new robot (referred to as the first robot 200-1 hereinafter) is arranged within the space, and is connected to the first AP 1000-1 from among the first AP 1000-1 and the second AP 1000-2, the at least one processor 130 may control the second robot 200-2 and the third robot 200-3 connected to the first AP 1000-1 to sense the first robot 200-1.

In an example case in which the first robot 200-1 moves and its connection with the first AP 1000-1 is disconnected, and the first robot 200-1 is connected to the second AP 1000-2, the at least one processor 130 may control the fourth robot 200-4 and the fifth robot 200-5 connected to the second AP 1000-2 to sense the first robot 200-1.

However, the disclosure is not limited thereto, and the at least one processor 130 can obviously update the location information of the first robot 200-1 by using various indoor positioning technologies.

For example, the at least one processor 130 may obtain location information corresponding to the location of the first robot 200-1 based on the strength of a Wi-Fi signal of the first robot 200-1 connected to the first AP 1000-1, and the latency.

For example, the at least one processor 130 may identify the location of the first robot 200-1 based on a Bluetooth low energy (BLE) signal of a beacon.

According to an embodiment, the at least one processor 130 may identify the location of the first robot 200-1 based on tagging of an RFID provided on the first robot 200-1, or identify the location of the first robot 200-1 based on a signal of an Ultra-Wideband (UWB).

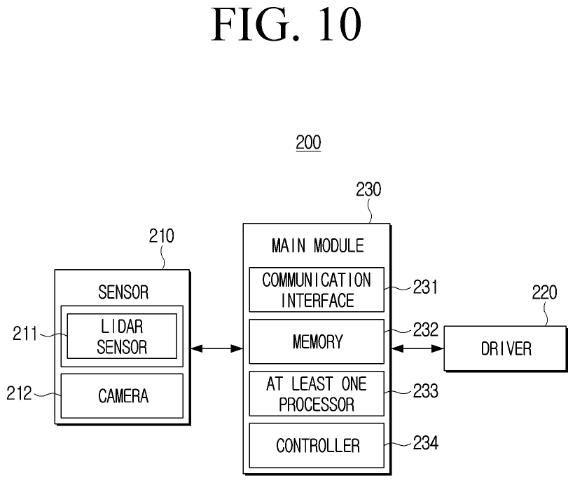

FIG. 10 is a block diagram for illustrating a robot according to an embodiment of the disclosure.

Referring to FIG. 10, each of the plurality of robots 200 includes a sensor 210, a driver 220, and a main module 230.

According to an embodiment, the sensor 210 includes a LiDAR sensor 211 and a camera 212, and the main module 230 includes a communication interface 231, a memory 232, at least one processor 233, and a controller 234.

The sensor 210 is a component for sensing various kinds of information. According to an embodiment, the at least one processor 233 may obtain various kinds of information based on sensing values of the sensor 210. For example, information obtained by the sensor 210 may include an image and depth information. The image may include RGB values of each of a plurality of pixels included in the image. The depth information may include a depth map including depth values of each of the plurality of pixels.

The LiDAR sensor 211 may shoot a light to a target object by using a light source, and detect the light reflected from the target object. The at least one processor 233 may identify the distance to the target object based on the time that took until a light was reflected from the target object (e.g., the target robot) and detected after the light was shot from the LiDAR sensor 211.

According to an embodiment of the disclosure, the LiDAR sensor 211 may be provided to detect a first direction (or shoot a light in a first direction) based on the robot 200. Here, the first direction may be a driving direction of the robot 200 or a direction toward the front side of the robot 200 in an example case in which the robot 200 drives forward.

For example, the LiDAR sensor 211 may detect a distance from an obstacle located on the front side of the robot 200 while the robot 200 is driving forward. However, this is merely an example, and the first direction may correspond to the side surface (e.g., the right side surface, or the left side surface, etc.) of the robot 200.

According to an embodiment, the robot 200 may include a plurality of LiDAR sensors 211, and the plurality of LiDAR sensors 211 may include a first LiDAR sensor provided to detect the first direction, or a second LiDAR sensor provided to detect a second direction opposite to the first direction (or shoot a light in a second direction).

Here, the second direction may be an opposite direction to a driving direction of the robot 200 in an example case in which the robot 200 drives forward, or a direction corresponding to the rear surface of the robot 200.

For example, the second LiDAR sensor 212 may detect a distance from an obstacle located on the rear side of the robot 200 while the robot 200 is driving forward. However, this is merely an example, and the second direction may correspond to the side surface (e.g., the right side surface, or the left side surface, etc.) of the robot 200. Also, the first direction and the second direction may be implemented as directions that are completely opposite to each other, but are not necessarily limited thereto, and they may be implemented as two different directions that are different by a specific angle or more.

According to an embodiment, the sensor 210 may include a camera 212. The camera 212 may include a stereo camera, an RGB-D camera, a Time of Flight (ToF) camera, etc. However, the disclosure not limited to this example, and the sensor 210 may include various sensors that can obtain images and depth information.

The driver 220 may control moving of the robot 200. For example, the driver 220 may move the robot 200, or stop the moving 200 that is moving, and control the moving speed and/or the moving direction of the robot 200.

For example, a movement type of the robot 200 may be a wheel type movement or a walking type movement.

According to an embodiment, the wheel type movement may mean a method in which the robot 200 moves through a rotation of a wheel. In an example case in which the robot 200 is a wheel type robot, the robot 200 may include one or more wheels. The driver 220 may include a device that generates power for rotating the wheel. For example, the driver 220 may be implemented as a gasoline engine, a diesel engine, a liquefied petroleum gas (LPG) engine, or an electric motor, etc. according to the used fuel (or an energy source).

The walking type movement may mean a method in which the robot 200 moves through moving of legs. In an example case in which the robot 200 is a walking type (e.g.: a two-legged walking robot, a three-legged walking robot, a four-legged walking robot, etc.), the robot 200 may include two or more legs supporting the robot 200. The legs may include a plurality of links, and a joint connected to the links. The driver 220 may include a device that generates power that makes the legs lifted or lowered by rotating the links with the joint as the center. For example, the driver 220 may be implemented as a motor and/or an actuator, etc.

Also, the driver 220 may control moving of a part of the robot 200. The driver 220 may be coupled between a first part (e.g.: a body) and a second part (e.g.: a head, an arm, etc.) of the robot 200. The driver 220 may rotate the second part. For example, the driver 220 may be implemented as a motor and/or an actuator, etc.

The main module 230 may be implemented as hardware, and include a communication interface 231, memory 232, at least one processor 233, and a controller 234.

The communication interface 231 may perform data communication with electronic apparatuses by control by the at least one processor 233. For example, the communication interface 231 may include communication circuitry that can perform data communication with the robot device 200 and an electronic apparatus by using at least one of data communication methods including a wired LAN, a wireless LAN, Wi-Fi, Bluetooth, Zigbee, Wi-Fi Direct (WFD), infrared Data Association (IrDA), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliances (WiGig), and RF communication.

In the memory 232, instructions, data structures, and program codes that can be read by the at least one processor 233 may be stored. Operations performed by the at least one processor 233 may be implemented by executing the instructions or codes of the programs stored in the memory 232.

The memory 232 may include memory of a flash memory type, a hard disk type, a multimedia card micro type, or a card type (e.g., SD or XD memory, etc.), and may include non-volatile memory including at least one of Read-Only Memory (ROM), Electrically Erasable Programmable Read-Only Memory (EEPROM), Programmable Read-Only Memory (PROM), magnetic memory, a magnetic disk, or an optical disk, and volatile memory such as Random Access Memory (RAM) or Static Random Access Memory (SRAM).

According to an embodiment, the at least one processor 233 controls the overall operations of the electronic device 200. Specifically, the at least one processor 233 may be connected with each component of the electronic device 200, and control the overall operations of the electronic device 200.

The at least one processor 233 may perform the operations of the electronic device 200 according to various embodiments by executing the at least one instruction stored in the memory 232.

The at least one processor 233 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 233 may control one or a random combination of other components of the electronic device, and perform operations regarding communication or data processing. The at least one processor 233 may execute one or more programs or instructions stored in the memory 232. For example, the at least one processor 233 may perform the method according to an embodiment of the disclosure by executing the one or more instructions stored in the memory 232.

According to an embodiment, the at least one processor 233 senses the target robot based on a control signal received from the electronic device 100, and transmit the sensing data obtained by sensing the target robot through the sensor 210 to the electronic device 100.

The controller 234 may control the components of the robot 200. The controller 234 may control the components of the robot 200 (e.g.: the sensor 210 and the driver 220, etc.) based on a signal provided from the at least one processor 233. For example, the controller 234 may generate a control signal by using a signal provided from the at least one processor 233, and provide the control signal to the components of the robot 200. Accordingly, the components of the robot 200 may perform an operation corresponding to an operation result of the at least one processor 233.

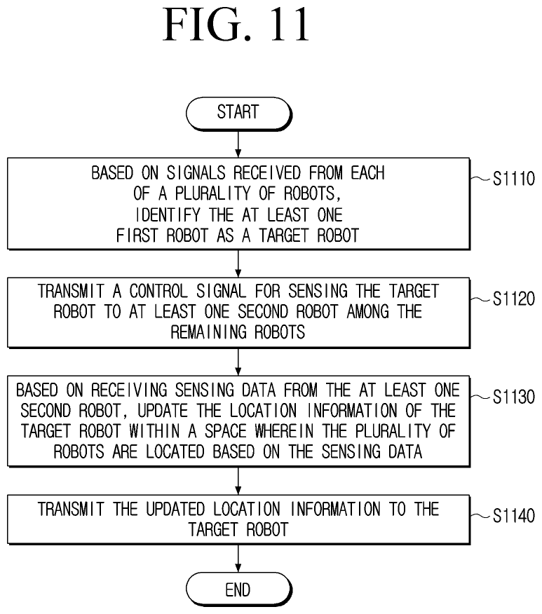

FIG. 11 is a flow chart for illustrating a control method of an electronic device according to an embodiment of the disclosure.

In operation S1110, the method may include identifying at least one first robot as a target robot. For example, the method may include receiving signals from one or more of a plurality of robots and identifying the at least one first robot as the target robot based on the signals received from the one or more of the plurality of robots. However, the disclosure is not limited thereto, and as such, according to an embodiment, the method may include identifying at least one first robot as a target robot, based on signals received from each of a plurality of robots, and based on request for update of location information of at least one first robot among the plurality of robots.

In operation S1120, the method may include transmitting a control signal for sensing the target robot to at least one second robot among the remaining robots. For example, the electronic device may transmit the control signal for sensing the target robot.

In operation S1130, the method may include updating location information of the target robot based on sensing data received from the at least one second robot. For example, based on receiving sensing data from the at least one second robot, the location information of the target robot within a space in which the plurality of robots are located is updated based on the sensing data.

In operation S1140, the method may include transmitting the updated location information to the target robot. For example, the electronic device may transmit the updated location information to the target robot in operation S1140.

The control method according to an embodiment further includes the operations of obtaining location information of each of the plurality of robots, and the updating operation S1130 may include the operation of updating the location information of the target robot based on the location information of the at least one second robot and the sensing data.

The sensing data according to an embodiment may include at least one of distance data between the at least one second robot and the target robot, pose data of the target robot, or sensing direction data of the target robot.

The identifying operation S1110 according to an embodiment may include the step of, based on failing to obtain the location information of the at least one first robot, or time that passed after obtaining the location information of the at least one first robot exceeding threshold time based on the signal received from the at least one first robot, identify that update of the location information of the at least one first robot is requested.

The identifying operation S1110 according to an embodiment may include the operation of, based on identifying that the location of the at least one first robot is included in an area in which moving is impossible in the map information corresponding to the space in which the plurality of robots are located based on the location information of the at least one first robot, identifying that update of the location information of the at least one first robot is requested.

The identifying operation S1110 according to an embodiment may include the operation of, based on identifying that the location of the at least one first robot is changed abnormally according to the signal received from the at least one first robot by a predetermined time interval, identifying that update of the location information of the at least one first robot is requested.

The identifying operation S1110 according to an embodiment may include the operation of, based on the order that each of the plurality of robots is connected with the electronic device through the communication interface, identifying the at least one first robot that is connected with the electronic device the latest among the plurality of robots as the target robot, or identifying the at least one first robot that is newly connected with the electronic device among the plurality of robots as the target robot.

The operation S1120 of transmitting to the at least one second robot according to an embodiment may include the operations of identifying the at least one second robot located within a threshold distance from the target robot among the remaining robots, and transmitting a control signal for sensing the target robot to the at least one second robot.

The control signal for sensing the target robot according to an embodiment may include the location information of the at least one first robot obtained based on the signal received from the at least one first robot, and the operation S1120 of transmitting to the at least one second robot may include the operation of transmitting the control signal that controls the at least one second robot to sense the at least one first robot based on the location information of the at least one first robot to the at least one second robot.

The control method according to an embodiment may include the operations of controlling each of the plurality of robots such that each of the plurality of robots senses the other robots, based on receiving the sensing data from each of the plurality of robots, obtaining the location information of each of the plurality of robots located within the space based on the plurality of sensing data, and transmitting map information corresponding to the space and corresponding location information to each of the plurality of robots.

Meanwhile, the various embodiments of the disclosure are not limited to an electronic device according to an embodiment, but also to all types of electronic devices that can communicate with a robot.

Meanwhile, the aforementioned various embodiments may be implemented in a recording medium that can be read by a computer or a device similar to a computer, by using software, hardware, or a combination thereof. In some cases, the embodiments described in this specification may be implemented as a processor itself. According to implementation by software, the embodiments such as processes and functions described in this specification may be implemented as separate software modules. Each of the software modules can perform one or more functions and operations described in this specification.

Meanwhile, computer instructions for performing processing operations of an electronic device according to the aforementioned various embodiments of the disclosure may be stored in a non-transitory computer-readable medium. Computer instructions stored in such a non-transitory computer-readable medium make the processing operations at the electronic device 100 according to the aforementioned various embodiments performed by a specific machine, when the instructions are executed by the processor of the specific machine.

A non-transitory computer-readable medium refers to a medium that stores data semi-permanently, and is readable by machines, but not a medium that stores data for a short moment such as a register, cache, and memory, etc. As specific examples of a non-transitory computer-readable medium, there may be a CD, a DVD, a hard disk, a blue-ray disk, a USB, a memory card, a ROM, and the like.

While preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic device comprising:
a communication interface;
a memory configured to store one or more instructions; and
at least one processor operatively connected with the communication interface and the memory, the at least one processor configured to execute the one or more instructions to: based on one or more signals received from one or more of a plurality of robots, identify a first robot, among the plurality of robots, as a target robot that requires location information to be updated,
transmit a control signal for sensing the target robot to at least one second robot among the plurality of robots,
based on receiving sensing data from the at least one second robot, update the location information of the target robot within a space in which the plurality of robots are located, and
control the communication interface to transmit the updated location information to the target robot.

2. The electronic device of claim 1,
wherein the at least one processor is configured to:
obtain location information of the at least one second robot, and
update the location information of the target robot based on the location information of the at least one second robot and the sensing data.

3. The electronic device of claim 2,
wherein the sensing data comprises:
at least one of distance data between the at least one second robot and the target robot, pose data of the target robot, or sensing direction data of the target robot.

4. The electronic device of claim 2,
wherein the at least one processor is configured to:
based on failing to obtain location information of the first robot, or time that passed after obtaining the location information of the first robot exceeding a threshold time based on a signal received from the first robot, identify that update of the location information of the first robot is required.

5. The electronic device of claim 2, wherein the memory is further configured to store map information corresponding to a space wherein the plurality of robots are located,
wherein the at least one processor is configured to:
based on identifying that a location of the first robot is included in an area in which moving is impossible in the map information, identify that update of the location information of the first robot is required.

6. The electronic device of claim 2,
wherein the at least one processor is configured to:
based on identifying that a location of the first robot is changed abnormally according to a signal received from the first robot within time interval, identify that update of the location information of the first robot is required.

7. The electronic device of claim 1,
wherein the at least one processor is configured to:
based on an order that each of the plurality of robots is connected with the electronic device through the communication interface, identify the first robot as most recently connected with the electronic device among the plurality of robots as the target robot, or identify the first robot that is newly connected with the electronic device among the plurality of robots as the target robot.

8. The electronic device of claim 1,
wherein the at least one second robot is located within a threshold distance from the target robot.

9. The electronic device of claim 8,
wherein the control signal for sensing the target robot comprises:
first location information of the first robot obtained based on a first signal received from the first robot, and
the at least one processor is configured to:
transmit, to the at least one second robot, the control signal that controls the at least one second robot to sense the first robot based on the first location information of the first robot.

10. The electronic device of claim 1,
wherein the at least one processor is configured to:
control each of the plurality of robots to sense one or more another robot, among the plurality of robots,
based on receiving a plurality of sensing data from each of the plurality of robots, obtain location information of each of the plurality of robots located within a space based on the plurality of sensing data, and
transmit map information corresponding to the space and corresponding location information to each of the plurality of robots.

11. A control method of an electronic device, the method comprising:
based on one or more signals received from one or more of a plurality of robots, identifying a first robot, among the plurality of robots, as a target robot that requires location information to be updated; transmitting a control signal for sensing the target robot to at least one second robot among the plurality of robots;
based on receiving sensing data from the at least one second robot, updating the location information of the target robot within a space in which the plurality of robots are located; and
transmitting the updated location information to the target robot.

12. The control method of claim 11, further comprising: obtaining location information of the at least one second robot, and
updating the location information of the target robot based on the location information of the at least one second robot and the sensing data.

13. The control method of claim 12,
wherein the sensing data comprises:
at least one of distance data between the at least one second robot and the target robot, pose data of the target robot, or sensing direction data of the target robot.

14. The control method of claim 12,
wherein the identifying comprises:
based on failing to obtain location information of the first robot, or time that passed after obtaining the location information of the first robot exceeding a threshold time based on a signal received from the first robot, identifying that update of the location information of the first robot is required.

15. The control method of claim 12,
wherein the identifying comprises:
based on identifying that a location of the first robot is included in an area in which moving is impossible in map information corresponding to a space in which the plurality of robots are located, identifying that update of the location information of the first robot is required.

16. The control method of claim 12,
wherein the identifying comprises:
based on identifying that a location of the first robot is changed abnormally according to a signal received from the first robot within time interval, identify that update of the location information of the first robot is required.

17. The control method of claim 11,
wherein the identifying comprises:
based on an order that each of the plurality of robots is connected with the electronic device through the communication interface, identifying the first robot as most recently connected with the electronic device among the plurality of robots as the target robot, or identify the first robot that is newly connected with the electronic device among the plurality of robots as the target robot.

18. The control method of claim 11,
wherein the at least one second robot is located within a threshold distance from the target robot.

19. The control method of claim 18,
wherein the control signal for sensing the target robot comprises:
first location information of the first robot obtained based on a first signal received from the first robot, and
wherein the transmitting the control signal to the at least one second robot comprises:
transmitting, to the at least one second robot, the control signal that controls the at least one second robot to sense the first robot based on the first location information of the first robot.

20. A computer readable recording medium, which includes computer-readable code that when executed by an electronic device, the method comprising:
based on one or more signals received from one or more of a plurality of robots, identifying a first robot, among the plurality of robots, as a target robot that requires location information to be updated; transmitting a control signal for sensing the target robot to at least one second robot among the plurality of robots;
based on receiving sensing data from the at least one second robot, updating the location information of the target robot within a space in which the plurality of robots are located; and
transmitting the updated location information to the target robot.
